(19) United States
(12) Patent Application Publication
(10) Pub. No.: US 2006/0085648 A1
(43) Pub. Date: Apr. 20, 2006

(54) Autonomic removal of a user from a client and network

(75) Inventors: Richard W. Cheston, Morrisville, NC (US); Daryl Carvis Cromer, Apex, NC (US); Howard Jeffrey Locker, Cary, NC (US); Randall Scott Springfield, Chapel Hill, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corp., Armonk, NY (US)

(21) Appl. No.: 10/967,762

(22) Filed: Oct. 16, 2004

(51) Int. Cl. H04L 9/00

(52) U.S. Cl. 713/182

(57) ABSTRACT

A method that restricts a user's access to critical data on a client and network by requiring renewal of a client's lease for accessing the network by an administrative utility of the network during each login by a user to the client. A user/client logon policy is created for each user and/or each client and stored at the lease server. The lease server executes a utility that utilizes the policies to control whether a user is allowed to access a particular client on the network. User access to the client and ultimately the network is only provided when the lease term is renewed for the client (and user). When a lease term is not renewed/extended, the user is blocked from accessing the client system.

### BACKGROUND OF THE INVENTION

1. Technical Field

The present invention relates generally to computer networks, and in particular to client systems on a computer network. Still more particularly, the preset invention relates to user access to client systems on a computer network.

2. Description of the Related Art

The use of conventional data networks, which provide users of client systems with access to network data and applications are known in the art. Typically, each network comprises multiple clients by which the users of the network are able to access the network information.

In conventional network, such as local area networks (LANs), the clients are typically connected to the network's background system via a local/physical connection. However, many of these conventional networks now allow for remote (and/or wireless) client access to the network. Also, the traditional small-scale LANs are being replaced by larger and more complex wide-area network (WANs).

Security is a key issue for most networks. With network systems, it is customary for critical data to be stored on the network server. Also, it is not uncommon for critical data to be stored on one or more of the client systems. This expanded use of the client enables the client to be more independent of the network for quicker user-access and application processing.

To protect critical data that is stored at the network server and/or directly on the client system, each authorized user is required to have a pre-approved user identifier (ID) and associated password, which are unique for that particular user. With these authentication credentials, a user is able to gain access to the client system and ultimately the critical data stored on the networks.

Networks utilized by large corporations, for, example, typically contain critical data on a private network computer/database. These are accessible by a user and/or client that is linked to the main network. As mentioned above, occasionally, critical data of the corporation may be stored on the client itself.

While the requirement for entry of entry of user authentication credentials offers some security/protection for the critical data on the network, there are some circumstances which require a previously authenticated user to be taken off the approved list of users. For example, contract employees may be given time-limited access to the network, and the network administrator is responsible for removing the employee's access credentials from the approved list when the contract expires.

Most current security systems that are based on authentication of user-credentials require the user to change passwords at a pre-set frequency. Thus, each user is allowed to keep a password for a pre-set period of time before the password expires and the user is forced to provide a different password to access the network. As an example, each user may be required to change his password every 60 days or after one hundred logins with a previous password. While the process of changing passwords helps to maintain security of the user account and ultimately the network, this method does not account for those administrative security features involving client access to the network and removing users with previously valid authentication credentials from the network or preventing access to certain critical data that may exist on the client system itself.

Currently for a system administrator to prevent a prior authorized user from accessing critical data on a network or client system, the system administrator has to log into the server and remove the user (i.e., user ID and password) from the network list of authorized users. If the administrator forgets to complete this removal, the user continues to have access to the client and network. Additionally, the network administrator must also go to the physical location of the client and change the client's configuration to prevent the user from accessing the client's hard drive. With large dynamic networks, multiple users may be added or deleted at multiple different times. The administrator is charged with the task of remembering when each of the users that are added is to be removed from the server. The administrator then has to log in to the server and remove the specific users. Then, the administrator has to go to each physical location and re-configured the respective client. There is no mechanism in place at the network-level or the client-level that permits removal of a user's security access to both the network and client systems (hard drives) without this two-step administrative operation performed for each removal that is completed.

The present invention recognizes that there is a need to be able to dynamically and automatically restrict access to both a client and network when a user's access permission is no longer valid. A method by which permission to access the client system and network is verified at the network level for each client before access is granted would be a welcome improvement. These and other benefits are provided by the invention described herein.

### SUMMARY OF THE INVENTION

Disclosed is a method, computer network, and computer program product that enables client access to a network is automatically verified and provided only when a client's lease to access the network has not expired or has been extended by the network server. A user's access to critical data on both the client and network is only permitted when the lease has been verified as current or extended.

A user/client logon policy is created for each user and/or each client on the entire network. These policies are stored at the network server and are accessible to a system administrator for updates or changes thereto. The network server executes a client lease renewal utility (CLRU) that utilizes the policies to control whether a user is allowed to access a particular client on the network. Each user/client is assigned a pre-set lease period when initially given access to the client and/or network, and the assigned lease period is utilized by the CLRU to determine whether the user is allowed to log on the client system during each logon attempt. The client may also given a pre-set lease period to enable server-level control of the login to the network by that client. The lease policy includes lease extension information, representing whether a user/client may extend the lease period for access to the network.

At each logon or at pre-specified time intervals provided by the client-implemented lease policy, the client requests an extension or renewal of it's existing lease (or creation of a new lease) with the network. User access to the client and ultimately the network is only provided when the lease term is renewed for the client and user. In one implementation where multiple successive accesses are permitted during a single lease term, client access is provided whenever the pre-set lease term has not expired.

When the lease is not extended for a particular client, the CLRU rejects the request from the client and prevents the user of the client from accessing critical information stored either at the client or elsewhere on the network (e.g., the network server/database). When a user is prevented from accessing the network and/or client, the user identifier (ID) is reset so that only the system administrator (via a master user ID password combination) or other authorized user may access the particular client. Thus, a single server-executing program controls when users/client systems are allowed access to the network and changes to the access permission are automatically provided to the client system.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram illustrating the main components of a computer network within which the features of the intention may advantageously be implemented;

FIG. 2 is a block diagram of a data processing system that may be selectively utilized as a client system or server according to one embodiment of the invention;

FIG. 3 is an exemplary lease database/table within which the lease periods and extension for particular clients and/or users are provided according to one embodiment of the invention;

FIG. 4A illustrates a flowchart of the process of establishing and transmitting a lease policy for a client according to one embodiment of the invention;

FIG. 4B is a flow chart illustrating the process by which the client responds to receipt of a lease ASF packet from the server according to one embodiment of the invention; and

FIG. 5 is a flow chart illustrating the process by which a non-renewal response is handled at the client during an attempt to logon by a user in accordance with one embodiment of the invention.

### DETAILED DESCRIPTION OF AN ILLUSTRATIVE EMBODIMENT

Disclosed is a method, computer network, and computer program product that enables client access to a network is automatically verified and provided only when a client's lease to access the network has not expired or has been extended by the network server. A user's access to critical data on the client or network is only permitted when the lease has been verified as current or extended.

As utilized within the invention, the term “lease” refers to a period during which authority has been given to a client and/or user to log in to and access a network and access critical data on the client. Similar to the plain language meaning of the term, a lease may be renewable or may be extended. However, these features are all controlled by a lease server and in particular a client lease renewal utility (CLRU) executing on the lease server.

A user/client logon policy is created for each user and/or each client on the entire network. These policies are stored at the network server and are accessible to a system administrator for updates or changes thereto. The network server executes a CLRU that utilizes the policies to control whether a user is allowed to access a particular client on the network. Each user/client is assigned a pre-set lease period when initially given access to the client and/or network, and the assigned lease period is utilized by the CLRU to determine whether the user is allowed to log on the client system during each logon attempt. The client may also given a pre-set lease period to enable server-level control of the login to the network by that client. The lease policy includes lease extension information, representing whether a user/client may extend the lease period for access to the network. The time interval for lease extension is policy driven and may be hourly, daily, etc.

Extension of the lease requires a client system submit a request for an extension to the network's lease server. The lease server includes the lease database that is pre-programmed by the network administrator. The network administrator decides whether to extend the lease for particular client and enters that information in the lease database.

At each logon on at pre-specified time intervals set by the user logon policy in place, the client is made to extend its existing lease with the network. Access to the client and ultimately the network is only provided the user when the lease term is renewed for the client and user. In another implementation in which multiple successive accesses are permitted during a single lease term, access is provided when the pre-set lease term has not expired. Thus, a system administrator is able to prevent users from logging on to the client computer by programming the server on the network not to extend the client lease when the client requests an extension.

When the lease is not extended for a particular client, the CLRU rejects the request from the client and prevents the user of the client from accessing critical information stored either at the client or elsewhere on the network (e.g., the network server/database). When a user is prevented from accessing the network and/or client, the user identifier (ID) is reset so that only the system administrator (via a master user ID password combination) or other authorized user may access the particular client. The network administrator is thus able to prevent a user from accessing critical information from the hard drive of the client and/or from the network without the administrator having to actually visiting the physical location of the client.

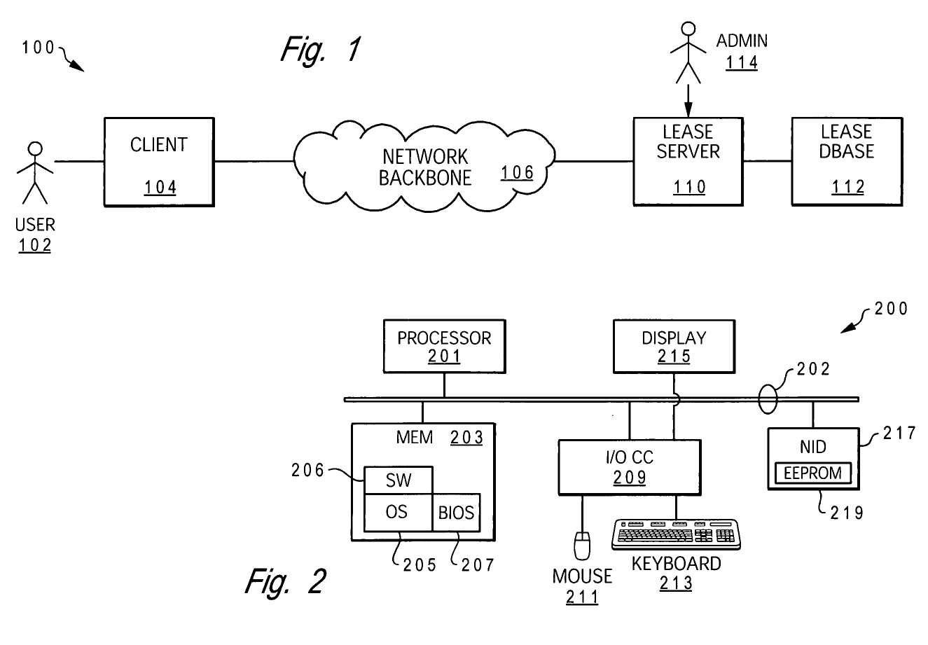

With reference now to the figures, and in particular FIG. 1, there is illustrated an exemplary network within which the features of the intention may be advantageously implemented. Network 100 includes network backbone 106 to which is connected lease server 110 with associated lease database 112. Lease server 110 is managed by an administrator (or administrative personnel) 114. In one implementation lease server 110 is a dedicated server that controls all lease functions on the network.

Also coupled to network backbone 106 is client system 104. Client system 104 is utilized by the user 102 to access the network 100 (i.e., lease server 110 and other components of network 100) via network backbone 106. According to the invention, administrator 114 is able to remotely control whether user 102 may access the hard drive of client system 104 and other components of network 100 without having to visit the physical location of client system 104.

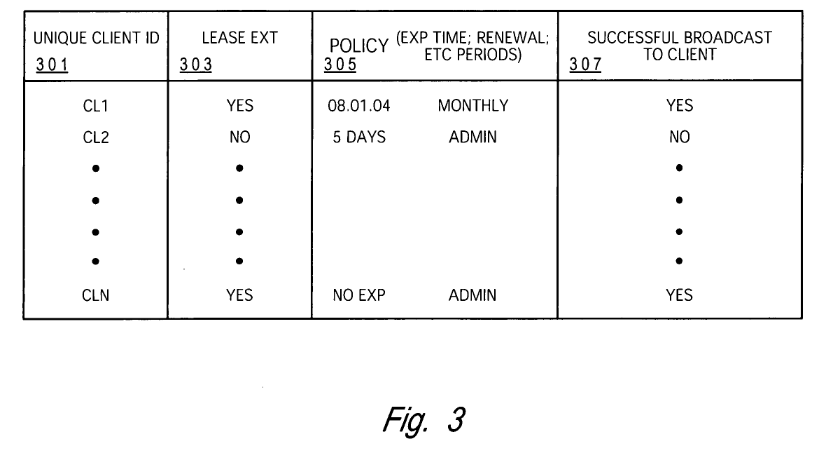

Turning now to FIG. 2, there is illustrated in an exemplary data processing system that may be selectively referred to as client system 104 or lease server 110. To better explain the invention, data processing system 200 is hereinafter referred to as client system 104 when a feature related solely to the client system 104 is being described and as server 110 when a feature related solely to the server 110 is being described.

Data processing system 200 includes processor 201, memory 203, and input/output controller (I/OCC) 209, each interconnected by a system bus 202. Also connected to system bus 202 is network interface device (NID) 217, which includes an EEPROM 219. EEPROM (or electrical erasable programmable read only memory) 219 is utilized within the client system 104 to store information received from the lease server 110 related to the lease extension policy for the client system 104. As described in greater details below, the information stored within EEPROM 219 is utilized by system BIOS (basic input/output system) to control whether a user is allowed to access or sign-on to the client system and/or the network.

I/OCC 209 controls input devices of which mouse 211 and keyboard 213 are illustrated. I/OCC 209 also controls output devices of which monitor 215 is illustrated. Stored within memory 203 are several software components of data processing system 200 including operating system (OS) 205, BIOS 207, and lease extension utility 206. When executed by processor 201, lease extension utility 206 enables implementation of some of the key features of the intention as described below. In client system 104, lease extension utility 206 is a utility associated with the system BIOS that generates the request for lease extension and triggers the BIOS operations that lock out the user/client from accessing the network when the lease extension is not provided. Within server 110, lease extension utility is CLRU and includes control functions that generate and maintain a lease extension policy database. CLRU also initiates the automatic broadcast of new lease policies as provided by one of the below-described embodiments of the invention.

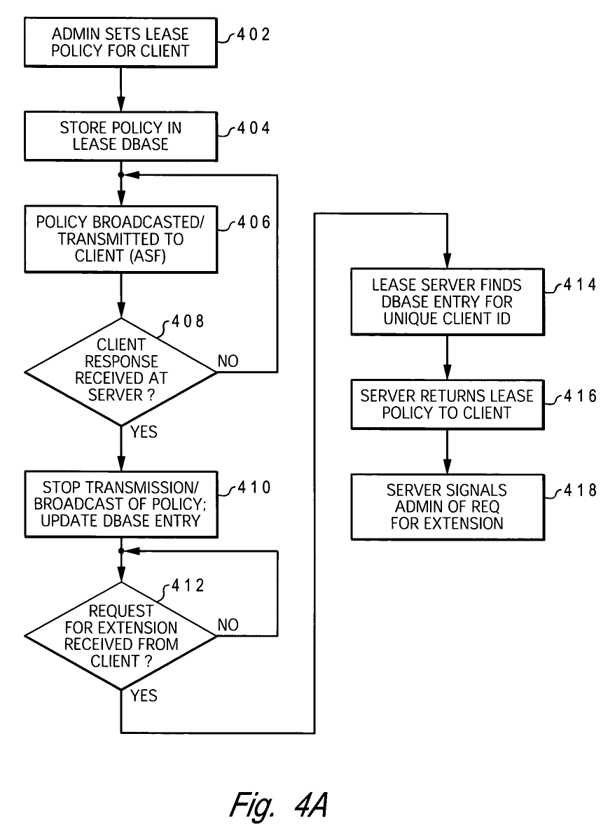

An exemplary lease database (or lease policy table) is illustrated in FIG. 3. As shown, database 300 is made up of multiple rows of information with each user/client represented by a row of information, which is in turn divided into columns of specific data. The first identification column 301 provides a list of unique client identifier (ID) of each of the multiple users/clients that have/had been given access to the network. Each client 10 and/or user 102 is associated with an entry in the database. The entry may include identifying indicia of the client/user such as the machine's serial number, MAC address, or client identifier (ID) (for client systems) and user logon ID (for users). Each of the identifications are unique to the specific user/client.

The second lease extension status column 303 of database 300 provides the current lease extension status that is provided by the administrator. As shown, several of the clients/users had been tagged to receive new leases (or extensions to existing leases), while other clients/users have not been given an extension. If the network administrator does not wish to extend the lease to a particular client the administrator opens the database and enters/selects a “no extension/lease” option within the second column of the database next to the particular client ID. As shown in the exemplary database, this entry may be a simple “no” or “yes” in the lease extension status column 303.

In the column next to the lease extension status is the lease extension policy column 305, which indicates when/if lease extensions are to be awarded to the particular client/user. The policy associated with the lease extension may include a specific date on which the lease expires, a specific period of time for which the lease is valid without an extension being required, etc. As a part of each policy, an indication is provided whether an automatic renewal of the lease is to be implemented or a lease-to-lease determination made by the administrator. The period for automatic renewals may be daily, monthly; etc.

A final acknowledgment column 307 within the database 300 indicates whether the client has received the broadcasted message about the renewal or award of a lease. This column applies only to the clients, as the users receive their lease renewal during logon to the client.

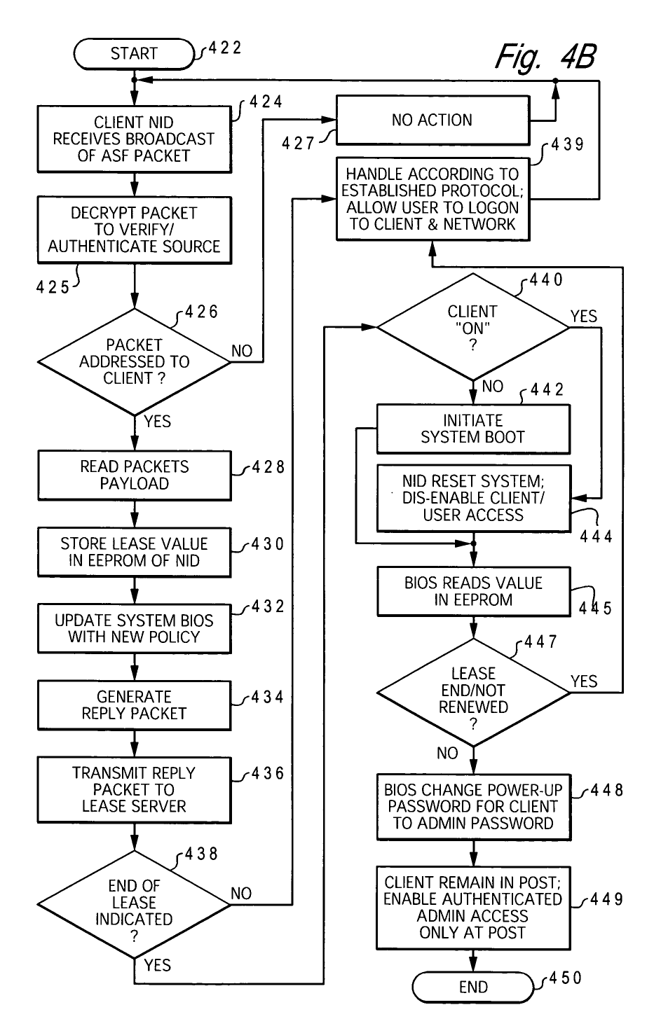

FIG. 4A illustrates the process at the server of establishing and broadcasting lease policies to clients on the network. The process begins at block 402 at which the administrator sets the lease policy for a particular client or group. The policy is then stored in the lease database, as shown at block for 404.

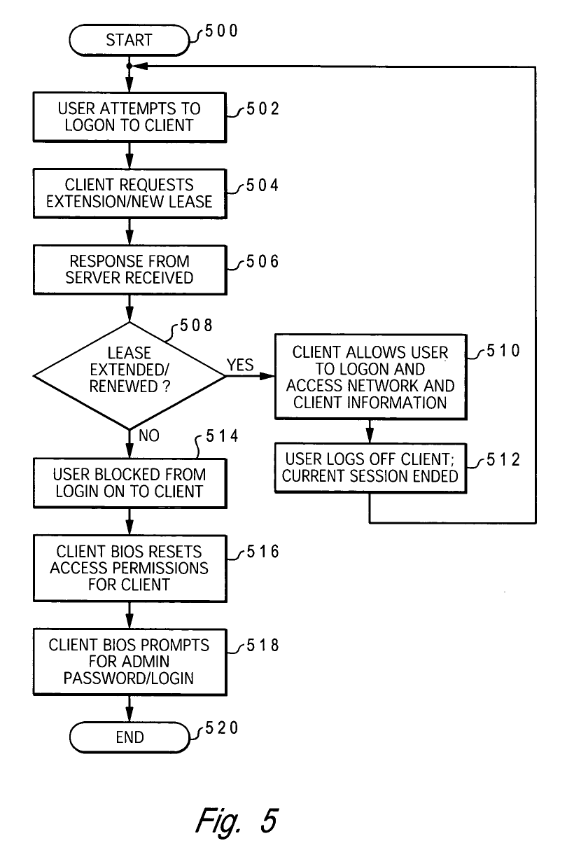

Two methods of alerting the clients of the lease policy is provided. The first method, generally illustrated by FIGS. 4A and 4B involves a broadcast of the policies to the network as soon as the policy is set. The second method, generally illustrated by FIG. 5, which is described below provides the policy via a direct transmission at the time the client attempts to log into the network.

Returning now to FIG. 4A and the broadcast method illustrated therein, once the administrator updates or changes the lease policy for a particular client and stores the new policy in the database, a lease packet is generated (with the client ID in the header) and transmitted to the client as shown at block 406. In the embodiment in which transmission occurs via a broadcast over the network, a packet is created utilizing industry standard alert standard format (ASF). Using ASF packet transfer protocol, the broadcast is periodically issued on the network until an acknowledgment packet is returned from the client indicating the client has received the ASF packet. The period between broadcasts is a design parameter determined based on the time required for the client to receive the broadcast of the ASF and respond with an acknowledgment packet. The period may also be calculated as a function of the limited network bandwidth used in the ASF hand shake.

After the broadcast of the ASF packet, a determination is made at block 408 whether a response is received from the particular client, which indicates that the client has received the broadcasted ASF packet. If the response packet is not received from the client, the server continues to broadcast the packet to network at a predetermined interval. However, when the client acknowledgement is received by the server, the sever stops transmission/broadcast of the ASF policy packets and updates the database entry to indicate that the client has received the updated lease policy, as depicted at block 410.

At block 412, a determination is made whether a request for a new lease or extension of the current lease has been received from the client. When the lease server has received a request, the CLRU checks the lease policy within the database entry corresponding to the client (using the unique client ID) at block 414. At block 416, the server retrieves the pre-set lease policy from the lease database and returns the lease policy to the client. Then, the server alerts the administrator that a request for lease extension or renewal was made by the client, as shown a block 418. In one implementation, this alert is provided as an entry within another column of the database of the time and date of the request.

The lease renewal process at the client is illustrated by FIG. 4B, which is now described. The process begins at block of 422, and then the client's NID receives a broadcast of the ASF packet from the server as shown at block 424. Since the packets are received via a broadcast (i.e., not directed transmission), the client's NID decrypts the packet to verify that the source is the lease server, as illustrated at block 425. The NID then parses the ASF packet for the client ID located in the header of the packet, and determines at block 426 whether the packet was addressed to the particular client. When the packet is not addressed to the client, no action is taken a shown at block 427. However, if the packet is addressed to the client, then the NID reads the packet's payload (part of execution code), as shown at block 428. The received lease policy information is stored within the EEPROM of the NID, as shown at block 430, and then a process of updating the system BIOS with the new lease policy is implemented at block 432.

Once the NID confirms that the packet is addressed to the client and is from the lease server, the NID generates an acknowledgment/reply packet as indicated at block 434 and, at block 436, the acknowledgement packet is transmitted to the lease server. The acknowledgement packet is generated and transmitted to indicate to the lease server that the broadcasted ASF packet was received and to stop the broadcast of the ASF packet.

A determination is then made at block 438 whether the payload indicates an end of lease. If the payload does not indicate an end of lease, then the NID handles the received ASF packets according to established protocol by which the lease is renewed, as shown at block 439. This policy may involve establishing a new password for the user to continue accessing the client and/or network or maintaining/adjusting the status quo of user access permission. In one embodiment, receipt of a lease policy broadcast that indicates an immediate cancellation of a lease may immediately block the user/client in an ongoing session from continuing to access the network.

The client's NID is configured to support ASF protocol. When the ASF packet indicates an end of lease, the NID determines at block 440 whether the client system is powered on. The NID is designed to operate even when the system is not powered up and to be able to trigger certain configuration changes to the BIOS regardless of whether the client is on (with running operating system (OS)) or off. The NID is thus able to can handle the received ASF packet.

If the client is not on, the NID stores the value in the EEPROM and waits for the system to be powered on. However, if the client is on, a system reboot is initiated, as shown at block 442, and the NID resets the system to disable the client/user access (configuration) to the network, as indicated at block 444. The system boot returns control to the system BIOS. The BIOS then reads the value stored in the EEPROM at block 445, and determines at block 447 whether the value indicates that the lease was renewed/extended. If the lease was not renewed/extended, then at block 448 the BIOS changes the power-up/login password for the client to that of the administrator. The client then remains in the POST stage as shown at block 449 at which only the administrator may access/login to the client. The process then ends at block 450.

With reference now to FIG. 5, there is illustrated an exemplary process by which the client-initiated method for direct transmission of a lease policy to the client is implemented. The process begins at block 500 and proceeds to block 502 at which the user attempts to logon to a client. The lease utility executing within the client submits a request to the lease server for an extension/renewal of a lease or a new lease as shown at block 504. According to this embodiment, access to client and network requires approval of the request. Notably, in another embodiment, the generation and transmission of the lease extension request may be provided via come user interface generated as one feature of the lease extension utility within client systems.

A response is received from the lease server at block 506, and at block 508 a determination is made whether the lease was extended/renewed. If the lease was extended/renewed, the client allows the user to logon and access the network and client information, as indicated at block 510. Following his access, the user logs off the client and the current session is ended as shown at block 512. Initiation of another, session then requires a new request for renewal/extension be transmitted by the client.

When the lease is not extended/renewed, the user is blocked from completing the current access request at block 514. The client's BIOS then resets the access permissions for the client at block 516 to that of the administrator, and the BIOS generates a prompt for the administrative password/login, as shown at block 518. The process then ends at block 520.

As a final matter, it is important that while an illustrative embodiment of the present invention has been, and will continue to be, described in the context of a fully functional computer system providing network access-request management functionality, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
issuing to a network server a lease renewal request when a user attempt to log on to a client is registered;
when a lease renewal response indicates that a renewal of a lease by a lease server, enabling the user to log on and access the client and network; and
when the lease renewal response indicates a non-renewal of the lease, preventing the user from accessing either the client or the network.

2. The method of claim 1, wherein said issuing a lease renewal request includes:
establishing a network connection to the lease server;
transmitting the lease renewal request to the lease server, said lease renewal request including an identification of said client.

3. The method of claim 1, wherein said enabling the user to log on includes:
verifying that said user has entered a correct user credential for accessing the client and network; and
providing said user with access to a hard drive and data on said client and said network.

4. The method of claim 1, wherein said preventing the user from accessing includes:
resetting a user access credential to an administrative credential, whereby the administrative credential is required to access said network from said client.

5. The method of claim 4, further comprising:
triggering a basic input/output system (BIOS) of the client to return the client to an initial login phase, wherein said triggering includes initiating a restart of said client.

6. The method of claim 5, further comprising:
receiving said lease renewal response within a packet transmitted from the lease server;
generating a reply packet indicating receipt of the lease renewal response; and
transmitting the reply packet to the lease server.

7. A method comprising:
providing at a lease server a lease renewal parameter for each client on a network; and
responsive to a receipt of a lease renewal request generated during an attempt by a user to log on to a client, transmitting a value of the lease renewal parameter to the client, wherein:
when said value indicates a non-renewal of said lease, said client is triggered to prevent said user from accessing either said client or said network.

8. The method of claim 7, further comprising:
when said value indicates a renewal of said lease, triggering said client to allow said user to access said client and said network.

9. The method of claim 7, wherein said transmitting further comprises:
parsing said lease renewal request for an identification of said client; and
including the client identification within a packet that includes said value; and
issuing said packet to the network, wherein said packet is transmitted to said client via one of a directed transmission or a broadcast.

10. The method of claim 9, further comprising:
when said packet is issued via a broadcast, continuing said broadcast until a reply packet is received from the client.

11. A computer program product comprising:
a computer readable medium; and
program code on said computer readable medium for completing a method comprising:
issuing to a network server a lease renewal request when a user attempt to log on to a client is registered;
when a lease renewal response indicates that a renewal of a lease by a lease server, enabling the user to log on and access the client and network; and
when the lease renewal response indicates a non-renewal of the lease, preventing the user from accessing either the client or the network.

12. The computer program product of claim 11, wherein said issuing a lease renewal request includes:
establishing a network connection to the lease server;
transmitting the lease renewal request to the lease server, said lease renewal request including an identification of said client.

13. The computer program product of claim 11, wherein said enabling the user to log on includes:
verifying that said user has entered a correct user credential for accessing the client and network; and
providing said user with access to a hard drive and data on said client and said network.

14. The computer program product of claim 11, wherein said preventing the user from accessing includes:
resetting a user access credential to an administrative credential, whereby the administrative credential is required to access said network from said client.

15. The computer program product of claim 14, said method further comprising:
triggering a basic input/output system (BIOS) of the client to return the client to an initial login phase.

16. The computer program product of claim 15, said method further comprising:
receiving said lease renewal response within a packet transmitted from the lease server;
generating a reply packet indicating receipt of the lease renewal response; and
transmitting the reply packet to the lease server.

17. A computer program product comprising:
a computer readable medium; and
program code on said computer readable medium for completing a method comprising:
providing at a lease server a lease renewal parameter for each client on a network; and
responsive to a receipt of a lease renewal request generated during an attempt by a user to log on to a client, transmitting a value of the lease renewal parameter to the client, wherein:
when said value indicates a non-renewal of said lease, said client is triggered to prevent said user from accessing either said client or said network.

18. The computer program product of claim 17, said method further comprising:
when said value indicates a renewal of said lease, triggering said client to allow said user to access said client and said network.

19. The computer program product of claim 17, wherein said transmitting further comprises:
parsing said lease renewal request for an identification of said client; and
including the client identification within a packet that includes said value; and
issuing said packet to the network, wherein said packet is transmitted to said client via one of a directed transmission or a broadcast.

20. The computer program product of claim 19, said method further comprising:
when said packet is issued via a broadcast, continuing said broadcast until a reply packet is received from the client.

21. A network comprising:
a lease server that completes the method of:
providing a lease renewal parameter for each client on the network;
responsive to a receipt of a lease renewal request generated during an attempt by a user to log on to a client,
transmitting a value of the lease renewal parameter to the client, wherein said packet is transmitted to said client via one of a directed transmission or a broadcast; and
when said packet is issued via a broadcast, continuing said broadcast until a reply packet is received from the client;
wherein:
when said value indicates a non-renewal of said lease, said client is triggered to prevent said user from accessing either said client or said network; and
when said value indicates a renewal of said lease, triggering said client to allow said user to access said client and said network; and
a client that completes the method of:
issuing to the network server a lease renewal request when a user attempt to log on to a client is registered;
receiving the lease renewal response within a packet transmitted from the lease server;
generating a reply packet indicating receipt of the lease renewal response;
transmitting the reply packet to the lease server;
when a lease renewal response indicates that a renewal of a lease by a lease server:
verifying that said user has entered a correct user credential for accessing the client and network;
enabling the user to log on and access the client and network; and
providing said user with access to a hard drive and data on said client and said network;
when the lease renewal response indicates a non-renewal of the lease, preventing the user from accessing either the client or the network:
resetting a user access credential to an administrative credential, whereby the administrative credential is required to access said network from said client;
triggering a basic input/output system (BIOS) of the client to return the client to an initial login phase, wherein said triggering includes initiating a restart of said client.
